(19) United States
(12) Patent Application Publication
(10) Pub. No.: US 2025/0173792 A1
(43) Pub. Date: May 29, 2025

(54) DATA STRUCTURE AND DISPLAY SYSTEM FOR TRANSFORMING, CLEANING, STORING, AND DISPLAYING PERFORMANCE INSIGHTS OF DATA FOR LIFE INSURANCE FROM MULTIPLE ISSUERS INCLUDING METHODS THEREOF

(71) Applicant: STOREFRONT FINANCIAL TECHNOLOGY, LLC, Scottsdale, AZ (US)

(72) Inventor: Matthew J. White, Scottsdale, AZ (US)

(21) Appl. No.: 18/716,908

(22) PCT Filed: Apr. 22, 2024
(86) PCT No.: PCT/US2024/025741

§ 371 Date: Jun. 5, 2024

Related U.S. Application Data
(60) Provisional application No. 63/497,699, filed on Apr. 21, 2023.

(51) Int. Cl. G06Q 40/06; G06Q 40/08

(52) U.S. Cl. CPC G06Q 40/06; G06Q 40/08

(57) ABSTRACT

Various examples of a computer-implemented display system and associated methods are disclosed. The display system includes a processor configured to estimate and display the realized historical components of change to the cash value of an insurance policy, including the performance of underlying subaccounts and indexed account segments for life insurance policies from various issuer sources allowing them to be compared and combined for multiple policies by implementation of a data structure that standardizes new values generated from information extracted from the multiple policies and transformed according to policy type.

### CROSS REFERENCE TO RELATED APPLICATIONS

This is a PCT application that claim benefit to U.S. provisional application Ser. No. 63/497,699 filed on Apr. 21, 2023 which is incorporated by reference in its entirety.

### FIELD

The present disclosure generally relates to the fields of computer graphic processing and visual display systems; and in particular, to a visual displays system generated by various database, analysis, and reporting functions as described herein.

### BACKGROUND

Conventional systems for managing input data of different types and formats and then providing associated reporting in various industries is lacking; particularly when end users need unique and varying parameters. For example, policy-level historical reporting that is provided to life insurance policyholders and their financial advisors is often limited to point-in-time data points and contained in mailed statements and/or PDF documents available online. While insurance issuers may provide online systems for accessing additional supplemental historical performance and accounting data for each policy, the completeness of information provided varies greatly from issuer to issuer-leaving policyholders and their advisors without an efficient and scalable method to compile a complete picture of a full historical financial outcome of a policy that is needed to make an informed investment decision to trade investment options within the policy, contribute, or withdraw assets. Additionally, the disparate and varying availability of policy accounting and performance data, as well as the differing labeling of data and different policy features between issuers creates limited points of comparability for realized performance and financial outcomes between two policies issued from different issuers. Further still, the data provided by issuers is often missing critical points, or contains incorrect data, preventing an accurate performance analysis and comparison of realized outcomes to original financial plan projections.

It is with these observations in mind, among others, that various aspects of the present disclosure were conceived and developed.

### SUMMARY

The present disclosure provides a number of examples that describe display systems and techniques for generating a display by forming a novel data structure configured for uniform issuer comparability. In the context of the disclosed methods, devices, techniques, apparatus, systems, and so on, the terms “operable to,” “configured to,” and “capable of” used herein are interchangeable.

In a first set of illustrative examples, the inventive concept includes a display system. The display system can include a display and includes a processor configured to access source issuer data defined from a plurality of files containing individual life insurance policy information, and generate an instance of a data structure from input of the plurality of files. The data structure defines a predetermined storage format including a set of parameters configured for accommodating queries for the investment performance and dissection of the components of change for the cash value of life insurance policies to all of the plurality of files collectively. In some examples, the processor identifies a type associated with each of the plurality of files, extracts information from each of the plurality of files, the historical details of a policy's cash value, extracted based on the type, applies one or more transformations to the information as extracted to generate new values corresponding to the set of parameters of the data structure, the one or more transformations uniquely tailored for the type of file, and maps the new values from each file to corresponding parameters of the set of parameters of the data structure to represent all of the plurality of files collectively by the data structure. The processor can further be configured to cause the display to render a performance metric being the realized historical change of a policy's cash value from all of the plurality of files defining the issuer data collectively by applying a sole query to the new values associated with the data structure.

In second set of illustrative examples, the inventive concept includes a method for displaying a realized historical financial performance for the cash value of individual life insurance policies with uniform issuer comparability, comprising steps of: caching source issuer or carrier data; for each file in the source issuer data identifying a file type; applying one or more transformations to the source issuer data based on the file type, each of the one or more transformations defining stored processes configured to prepare new values from the source issuer data in view of a predetermined data structure, the new values defining separate new objects that conform to the data structure; and appending output of the transformations to parameters of the data structure in a database, the database configured for generating a performance metric being the realized historical change of a policy's cash value from all of the plurality of files defining the source issuer data collectively in view of a sole query to the new values.

In a third set of illustrative examples, the inventive concept includes a non-transitory, computer-readable medium storing instructions encoded thereon; wherein the instructions, when executed by one or more processors, cause the one or more processors to perform operations to: access source issuer data defined from a plurality of files containing individual life insurance policy information; generate an instance of a data structure from input of the plurality of files, the data structure defining a predetermined storage format including a set of parameters configured for accommodating queries for the investment performance and dissection of the components of change for the cash value of life insurance policies to all of the plurality of files collectively; and generate a performance metric being the realized historical change of a policy's cash value from all of the plurality of files defining the issuer data collectively by applying a sole query to the new values associated with the data structure.

The foregoing examples broadly outline various aspects, features, and technical advantages of examples according to the disclosure in order that the detailed description that follows may be better understood. It is further appreciated that the above features described in the context of the illustrative example method, compositions, and systems are not required and that one or more features may be excluded and/or other additional features discussed herein may be included. Additional features and advantages will be described hereinafter. The conception and specific examples illustrated and described herein may be readily utilized as a basis for modifying or designing other structures for carrying out the same purposes of the present disclosure. Such equivalent constructions do not depart from the spirit and scope of the appended claims.

### BRIEF DESCRIPTION OF THE DRAWINGS

FIG. 1A is a simplified block diagram of a computer-implemented display system for generating a visual display of the realized historical financial performance for the cash value of individual life insurance policies with uniform issuer comparability described herein.

FIG. 1B is a simplified block diagram of an example method associated with the system example described herein.

FIG. 1C is a diagram illustrating possible data flow example aspects of the system of FIG. 1A.

FIG. 1D is an illustration of a portion of the system of FIG. 1A demonstrating data extraction from source issuer data, transformation of the extracted data to generate transformed records (new values) suitable for mapping to parameters of the novel data structure, and the data cleansing of the new values to detect anomalies or errors in the source data prior committing the new values to storage.

FIG. 1E is an illustration of portion of the example of FIG. 1D demonstrating how multiple assimilators may deployed against a plurality of source issuer data files based on the data type for each file, with the outputs of the various assimilators consolidated to generate the total assimilator output.

FIG. 1F is an illustration of additional aspects of the example from FIG. 1D demonstrating in further detail how an assimilator matching the source issuer data type will extract data, transform it to new values, in particular for the labeling of certain data values, and then conform it to a novel data structure capable of storing data from multiple issuers as the assimilator output.

FIGS. 2A-2B depict a general data flow diagram associated with the Performance Analysis Engine portion of the system of FIG. 1.

FIG. 3A-3B depict a relationship diagram illustrating database table flow associated with example tables created, populated, modified, or otherwise implemented via the Performance Analysis Engine system of FIG. 1.

FIG. 4A is an example of a process flow associated with the Performance Analysis Engine system of FIG. 1.

FIGS. 4B-4C are example output reporting metrics associated with the process flow of FIG. 4A.

FIGS. 5A-5D are example screenshots of the user interface and reporting produced by the system of FIG. 1 and relate to examples of the output described in FIGS. 4B-4C.

FIG. 6 is a simplified schematic diagram illustrating an exemplary computing device that may be configured to implement various functions and methods described herein.

Corresponding reference characters indicate corresponding elements among the view of the drawings. The headings used in the figures do not limit the scope of the claims.

### DETAILED DESCRIPTION

Aspects of the present disclosure relate to embodiments of a computer-implemented display system and associated methods for generating a visual display of the realized historical financial performance for the cash value of individual life insurance policies with uniform issuer comparability. In some examples, the display system includes a processor configured to access source issuer data defined from a plurality of files containing individual life insurance policy information, and generate an instance of a data structure from input of the plurality of files. The data structure defines a predetermined storage format including a set of parameters configured for accommodating queries for the investment performance and dissection of the components of change for the cash value of life insurance policies to all of the plurality of files collectively. In some examples, the processor identifies a type associated with each of the plurality of files, extracts information from each of the plurality of files including the historical details of a policy's cash value based on the type, applies one or more transformations to the information as extracted to generate new values corresponding to the set of parameters of the data structure, the one or more transformations uniquely tailored for the type of file, and maps the new values from each file to corresponding parameters of the set of parameters of the data structure to represent all of the plurality of files collectively by the data structure. The processor can further be configured to cause a display to illustrate a performance metric being the realized historical change of a policy's cash value from all of the plurality of files defining the issuer data collectively by applying a sole query to the new values associated with the data structure.

In some examples, the processor is configured to generate at least one report including a plurality of metrics associated with an end user in response to input data via by a user interface. In some examples, the plurality of metrics defines investment performance and accounting summary of insurance policies or accounts as well as the various sub-accounts and features within them over a period of time. In general, the display system leverages the processor for data acquisition, analysis, and report generation; and leveraging various reporting tools described herein, can provide monthly time-weighted return reporting for individual policies both before and after insurance fees and accommodates reporting on individual subaccount holdings and indexed segment accounts within policies as well as portfolio-level performance for clients with multiple insurance policies.

The inventive concept is a scalable technical solution to increases the value, understandability, accessibility, and accuracy of financial policy-level data within the insurance industry by improving raw financial policy-level data from any insurance issuer into a novel unified data structure through a combined system of technical transformations “assimilators” and quality control algorithms “purifiers” performed by one or more processors.

### Introduction & Technical Problems

Historically, in order display the historical performance outcome for the cash value of a policy, or portfolio of policies, as well as the underlying subaccounts to an end user, one must:
a. manually enter and/or transpose policy-level information from issuer statements, websites, or downloaded information into a spreadsheet of some kind.
b. manually re-enter the value of each policy cash value, and its underlying subaccount or indexed account holdings, from issuer data over multiple points of time for the full period of the policy history;
c. make a judgement about which types of transactions should be considered an investment gain, deduction, contribution, or insurance charge;
d. (in the case of a portfolio of policies) group insurance transactions by type and exercise professional judgement about which types of transactions should be grouped similarly even though they contain different descriptions or labels by each issuer
e. (in the case of a portfolio of policies) group similar investments together and exercise professional judgment about whether issuer documentation describes the same investment even if labels/naming conventions differ.
f. If the policy, or portfolios of policies, contain indexed account investments the individual must collect publicly available market index data from the internet and compare that market information against the terms of each indexed account segment in their policy, or group of policies, to manually calculate if there is a potential deferred credit for each of their indexed account segments (which could number well over 100 in certain situations).
g. Arranging the information into the correct chronological sequence for each sub-period, per policy, per subaccount/indexed account segment.
h. Perform a series of manual financial calculations to calculate the investment performance and cumulative historical amounts of important policy activities such as:
   i. Contributions
   ii. Cost of Insurance deductions
   iii. Insurance rider charge deductions
   iv. Investment gain
   v. Investment return since initial investment represented as a % rate-of-return
i. Repeat this activity (steps a-h) for every requested to gather historical performance insights.

This type of evaluation requires several hours of manual data entry and manipulation for every single policy, including re-entering information from varying types of statements, websites, and/or spreadsheets, and requires a very high degree of industry knowledge to piece together a complete mosaic of historical financial investment performance. For investors or groups with a large number of insurance policies to evaluate, from various issuers, that require a regular frequency of performance insights, it is not technically possible for any one individual to evaluate the performance of the cash value for that insurance portfolio of policies. Furthermore, if information from the insurance issuer is incomplete or contains errors then the resulting performance evaluation will be incorrect for the policy cash value and the subaccounts/indexed account segments within. This could potentially lead to financial decisions that are flawed in their assumptions.

To better serve investors holding cash value life insurance policies and annuities in a scalable fashion the financial industry needs a technical solution to transform, organize, and store historical data from various insurance issuers and to be able to generate financial performance insights from that said data, regardless of the source format, frequency, style, labeling, or transmission method.

### Technical Solutions

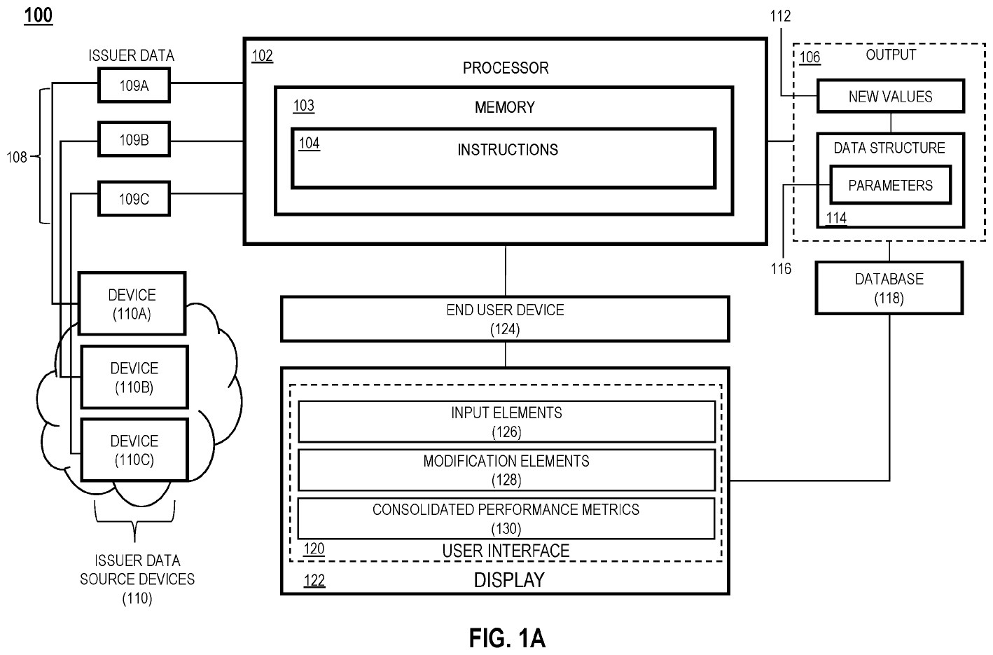

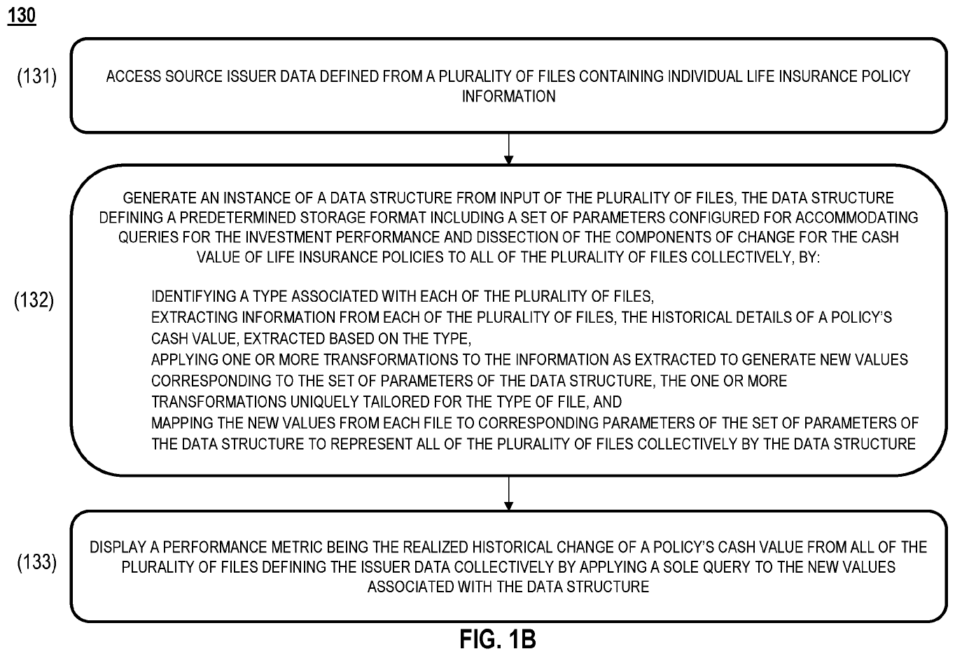

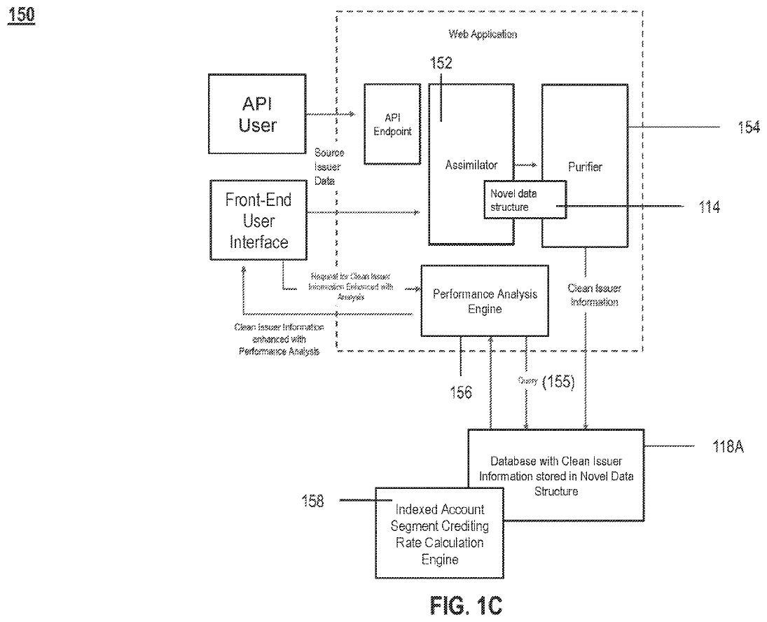

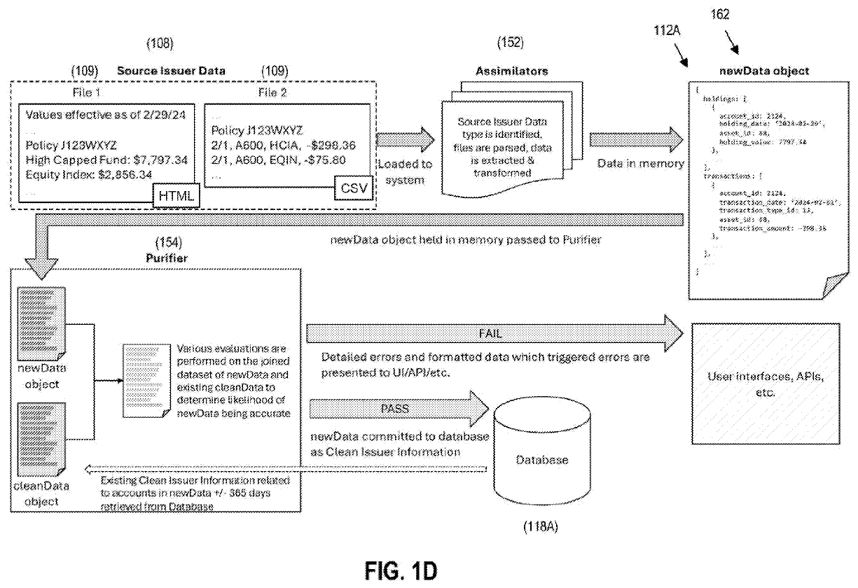

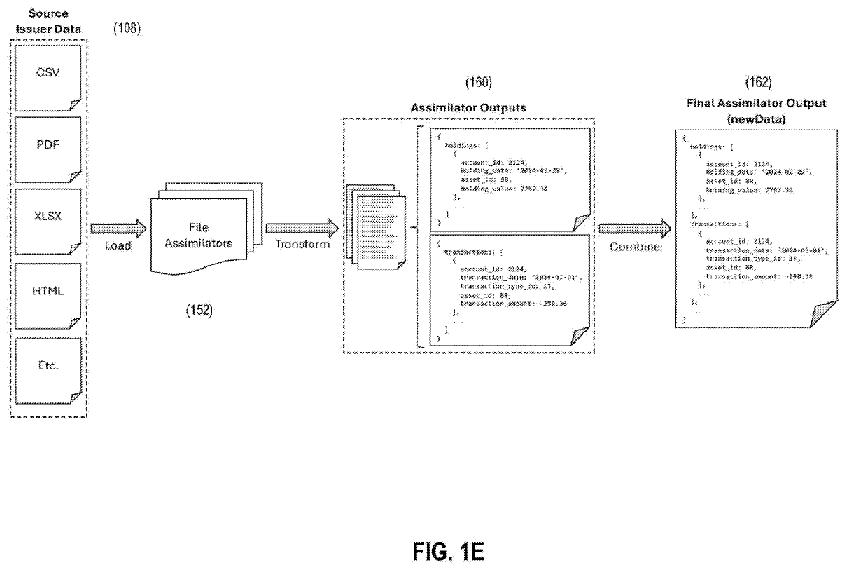

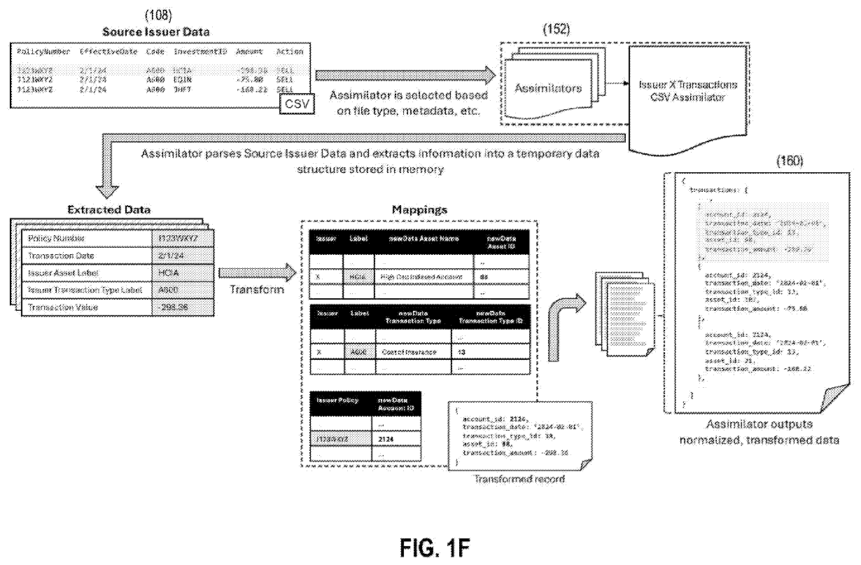

Referring to FIGS. 1A-1B, examples of a computer-implemented display system, designated display system 100, are configured for performing data transformations to generate new values according to a novel data structure, and the new values accommodate computation of a plurality of metrics for display to an end user (to, e.g., track investment performance and accounting summary of the cash value of insurance products) across multiple issuer policy datasets, as further described herein. In general, as indicated and described herein, the display system 100 includes at least one processor 102 or processing element that is configured to perform various operations, such as data transformations, computations, and other processes described herein.

Operations executed by the processor 102 can be implemented via instructions 104 stored in a memory 103 including any form of machine-readable medium. For example, the instructions 104 can be implemented as code and/or machine-executable instructions executable by the processor 102 that may represent one or more of a procedure, a function, a subprogram, a program, a routine, a subroutine, a module, an object, a software package, a class, or any combination of instructions, data structures, or program statements, and the like. In other words, one or more of the features for reporting management and processing described herein may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium (e.g., the memory 103 and/or the memory of computing device 1200), and the processor 102 performs the tasks defined by the code. In some embodiments, the processor 102 is a processing element of a cloud such that the instructions 104 may be implemented via a cloud-based web application.

As indicated, the processor 102 can be configured via the instructions 104 to generate output 106 via consolidation and transformation of information from input issuer data 108 derived from a plurality of issuer data source devices 110 (illustrated by example as devices 110A-110C). Issuer data 108 can include a plurality of files 109 or datasets, shown in FIG. 1A as files 109A-109C. In a specific example, the processor 102 as configured generates new values 112 from the issuer data 108 for each of the plurality of files 109. The new values 112 are generated in view of a novel data structure 114 defining a set of variables or parameters 116. The new values 112 as generated can be mapped to, populate, or otherwise associated with corresponding parameters 116 and stored in a database 118, as further described herein.

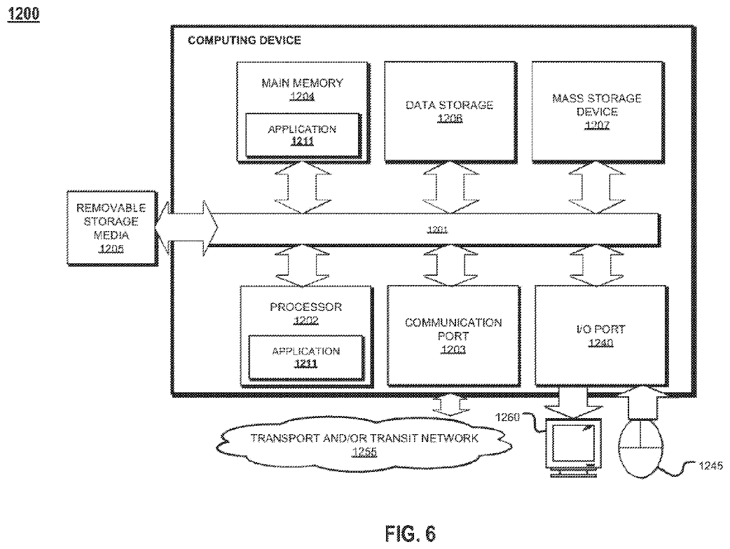

As further shown, the system 100 can include a user interface (UI) 120 rendered via a display 122; the display 122 integrated or otherwise in operable communication with an end-user computing device 124 such as a laptop, mobile device (e.g., tablet or mobile phone), a general-purpose computing device, and the like. In general, an end user can interact with and engage the UI 120 by engaging any number or type of input device (e.g., input device 1245 of FIG. 6) in operable communication with the end user device 124, such as a mouse, keyboard, touchscreen, and the like. As an example, the end user can initiate a report request and provide input data such as information about one or more accounts (e.g., insurance policies) via input elements 126 of the UI 120, can modify report preferences via modification elements 128 of the UI 120, and based on information and engagement with the input elements 126 and modification elements 128, can access consolidated performance metrics 130 generated by the processor 102 and rendered via the UI 120 along the display 122. Information about reports, report templates, tables, and the like can be stored in database 118.

Referring to FIG. 1B, an example process 130 or method is shown for implementing the system of FIG. 1A and other system examples described herein. As indicated in block 131, the processor 102 accesses source issuer data 108. Source issuer data 108 can take many forms and formats, including but not limited to CSV, XLSX, XLS, JSON, TXT, PDF, HTML, XML, DOC, and DOCX file types, and the data can be accessed from various insurance issuers of cash value life insurance policies/annuities. The processor 102 as configured can access the source issuer data 108 in a format and schema that is native to a given unique administration system (associated with an issuer data source device 110) including any limitations on reporting policy-level data. As such, it is not required that issuer data sources (carriers) conform their data to a common standard to transmit or provide data for reporting.

As indicated in block 132 of FIG. 1B, the processor generates an instance of a data structure (114) from input of the plurality of files (109). The data structure (114) defines a predetermined storage format including a set of parameters (116) configured for accommodating queries for the investment performance and dissection of the components of change for the cash value of life insurance policies to all of the plurality of files collectively.

### Data Structure Example

The following is a list of example parameters, objects, and other organizational elements of the data structure 114.
User object
   user_id as primary key
   user_name as string
   Other required key-value pairs necessary for authentication from selected authentication framework
Issuer object
   issuer_id as primary key
   issuer_name as string
   additional key-value pairs not related to core function
Issuer Product object
   issuer_product_id as primary key
   issuer_product_name as string
   issuer_id as foreign key to Issuer object
   additional key-value pairs not related to core function
Assimilator object
   assimilator_id as primary key
   issuer_product_id as foreign key to Issuer Product object.
   assimilator_data_type as string to contain the file suffix that it may be applied against
   assimilator_matching_function as referenced stored function to perform on data to identify if the assimilator is applicable
   assimilator_transformation as referenced stored function containing set of instructions to execute against data in order to transform data
   additional key-value pairs not related to core function
Account object
   account_id as primary string
   account_number as string
   issuer_id as foreign key to Issuer
   product_id as foreign key to Issuer Product object
   default_template as foreign key to Template object
   client(s) as many-to-many relationship with Client object
   firm as many-to-many relationship with Firm object
   portfolio(s) as many-to-many relationship with Portfolio object
   additional key-value pairs not related to core function
Portfolio object
   portfolio_id as primary string
   portfolio_name as string
   firm_id as many-to-many relationship with Firm object
   account(s) as many-to-many relationship with Account object
   client(s) as many-to-many relationship with Client object
   additional key-value pairs not related to core function
Asset Class object
   asset_class_id as primary key
   asset_class_name as string
   additional key-value pairs not related to core function
Asset object
   asset_id as primary key
   asset_name as string
   asset_class as foreign key to Asset Class object
   issuer_id as foreign key to Issuer
   additional key-value pairs not related to core function
Holding object
   holding_id as primary key
   account_id as foreign key to Account object
   asset_id as foreign key to Asset object
   holding_date as date
   holding_value as decimal
   units as double
   unit value as double
   holding_source_price_date as date
   holding_source_id as foreign key to Asset Mapping object
   additional key-value pairs not related to core function
Transaction Type object
   transaction_type_id as primary key
   transaction_type as string
Asset Mapping object
   asset_mapping_id as primary key
   asset_id as foreign key to Asset object
   issuer_id as foreign key to Issuer object
   source_issuer_asset_label as string
Transaction Mapping object
   transaction_mapping_id as primary key
   transaction_type_id as foreign key to Transaction object
   issuer_id as foreign key to Issuer object
   source_issuer_transaction_label as string
Supplemental Mapping object
   supplemental_mapping_id as primary key
   supplemental_type_id as foreign key to Supplemental object
   issuer_id as foreign key to Issuer object
   source_issuer_supplemental_label as string
Transaction object
   transaction_id as primary key
   transaction_date as date
   account_id as foreign key to Account object
   asset_id as foreign key to Asset object
   transaction_amount as decimal
   transaction_type_id as foreign key to Transaction Type object.
   transaction_source_transaction_code as foreign key to Transaction Mapping object
   additional key-value pairs not related to core function
Supplemental Type object
   supplemental_type_id as primary key
   supplemental_type as string
Supplemental object
   supplemental_id as primary key
   account_id as foreign key to Account object
   supplemental_type as foreign key to Supplemental object
   supplemental_source_supplemental_code as foreign key to Supplemental Mapping object
   supplemental_date as date
   supplemental_value as decimal
   additional key-value pairs not related to core function
Market Index object
   market_index_id as primary key
   market_index_name as string
   market_index_source as string
   market_index_source_identifier as string
   additional key-value pairs not related to core function
Market Index Value object
   market index_value_id as primary key
   market index as foreign key to Market Index object
   market_index_value_date as date
   market index value as decimal
   additional key-value pairs not related to core function
Indexed Account object
   indexed_account_id as primary key
   indexed_account_name as string
   issuer_id as foreign key to Issuer object
   additional key-value pairs not related to core function
Indexed Terms object
   indexed_terms_id as primary key
   indexed_account_id as foreign key to Indexed Account object
   issuer_product_id as foreign key to Issuer Product object
   indexed_terms_effective_date as date
   floor_rate as double
   cap_rate as double
   multiplier_rate as double
   booster rate as double
   indexed_charge_rate as double
   indexed_underlying as json_blob containing for each underlying:
      market_index_id as foreign key to Market Index object
      underlying_allocation as double summing to 100% for all underlying
      underlying_hurdle_rate as double
      underlying_floor_rate as double
      underlying_cap_rate as double
      underlying_participation_rate as double
Indexed Segment object
   indexed_segment_id as primary key
   indexed_account_id as foreign key to Indexed Account object
   issuer product_id as foreign key to Issuer Product object
   indexed_segment_start_date as date
   indexed_segment_maturity_date as date
   indexed_segment_display_name as string
   additional key-value pairs not related to core function
Indexed Segment Return object
   indexed_segment_return_id as primary key
   indexed_segment_return_start_date as date
   indexed_segment_return_end_date as date
   indexed_segment_return_crediting_rate as double
   indexed_segment_return_matured as Boolean.
   additional key-value pairs not related to core function
Policy Segment object
   policy_segment_id as primary key
   policy_segment_date as date
   indexed_segment_id as foreign key to Indexed Segment object
   policy_segment_transfers_in as decimal
   additional key-value pairs not related to core function
Illustration object
   illustration_id as primary key
   account_id as foreign key to Account object
   policy_year as integer
   assumed_rate gross as double
   assumed_rate_net as double
   gross_premium as decimal
   charges_load as decimal
   charges_coi as decimal
   charges_me as decimal
   charges_admin as decimal
   charges_other as decimal
   charges_total as decimal
   earnings as decimal
   accumulated_value as decimal
   surrender_value as decimal
   surrender_charge as decimal
   surrender_enhancement as decimal
   death benefit as decimal
   distribution_policy_loan as decimal
   distribution_withdrawal as decimal
   distributions_total as decimal
   loan_interest_charged as decimal
   loan_outstanding as decimal
   additional key-value pairs not related to core function
Financing object
   financing_id as primary key
   account_id_as foreign key to Account object
   lender as string
   financing_rate as double
   financing_principal as decimal
   financing_balance as decimal
   balance_date as date
   additional key-value pairs not related to core function
Client object
   client_id as primary key
   client_name as string
   user as one-to-one relationship with User object from authentication framework
   accounts as many-to-many relationship with Account object
   portfolios as many-to-many relationship with Portfolios object
   firm as one-to-many relationship with Firm object
   additional key-value pairs not related to core function
Firm object
   firm_id as primary key
   firm name as string
   users as many-to-one foreign key to User in authentication framework
   additional key-value pairs not related to core function
Module object
   module_id as primary key
   module_name as string
   additional key-value pairs not related to core function
Template object
   template_id as primary key
   template_name as string
   template_description as string
   css_file as string #path for decorations on template like logo and color schemes
   show_period_1 as Boolean
   show_period_2 as Boolean
   show_period_3 as Boolean.
   show_as_of_date as Boolean
   show_net_return as Boolean
   show_unit_value as Boolean
   show_decimals as Boolean
   show_dash logic as Boolean
   show_historical_returns as boolean
   period_las string
   period_2 as string
   period_3 as string
   custom_begin_1
   custom_end_1
   custom_begin_2
   custom_end_2
   custom_begin_3
   custom_end_3
   modules as json blob containing an order list of related Module objects based on module_id
   additional key-value pairs not related to core function
Analysis object
   analysis_id as primary key
   analysis_ran_by as foreign key to User object
   analysis_ran_on as datetime
   analysis portfolio as foreign key to Portfolio object
   analysis_account as foreign key to Account object
   analysis_path as string to filepath where complete record is stored in application
   analysis_messages as string to hold an outputs from the Analysis engine with errors or notices
Disclosure object
   disclosure_id as primary key
   disclosure_name as string
   disclosure_description as string
   contents as string
   disclosure_accounts as many-to-many relation with Accounts object
   disclosure firms as many-to-many relation with Firms object
   disclosure_portfolios as many-to-many relation with Portfolios object
   additional key-value pairs not related to core function.
Note that ‘additional key-value pairs not related to core function’ typically will include fields like:
   Active=Boolean of whether to object is relevant data or not. Changed to false when object is replaced or deleted.
   Modified_on=date auto-updated on change of object
   Created_on=date auto-created on initiation of object
   Modified_by=foreign key to user for audit purposes
   Created_by=foreign key to user for audit purposes
   Object_notes=string for any relevant data tracking purposes or user references to remember details on an object
   Object_metadata=json blob for additional storage of supplemental data

Continuing with block 132, in some examples, the processor 102 identifies a type associated with each of the plurality of files 109. In some examples, the processor 102 can be configured to algorithmically determine which issuer and which policy type of an issuer the source issuer data 108 pertains to. The processor 102 then extracts information from each of the plurality of files 109 including the historical details of a policy's cash value, based on the type of the file, and applies one or more transformations to the information as extracted from the plurality of files 109 to generate new values 112 corresponding to the set of parameters 116 of the data structure 114. The one or more transformations are uniquely tailored for the type of file given. The processor can further map the new values 112 from each file (109) to corresponding parameters of the set of parameters 116 of the data structure 114 to represent all of the plurality of files (109) collectively by the data structure 114 in a unified, consolidated, and/or standardized format.

As indicated in the diagram 150 of FIG. 1C, in some examples the system 100 can include one or more “assimilators” designated assimilators 152 and one or more “purifiers” designated purifiers 154. Assimilators can include machine-readable instructions executed by the processor 102 to transform policy-level Source Issuer Data output from disparate issuer systems into a novel, unified data structure that is capable of accepting, classifying, and storing data based on each issuer's unique output format(s), transaction types, transmission frequency, investment options, transaction labels, investment option names, rider features, indexed account terms, and other unique policy features. The operations performed by the processor 102 implementing the assimilators 152 provides, via a single system, the ability to apply algorithms to perform transformations on data sources of varying issuers to create a new data structure 114 that is uniform across all issuers in the insurance industry and allows for comparability, analysis, and combined performance calculations across different issuer policies by users. This is a technical improvement/solution to prior methods because performing the transformations upon receipt of the Source Issuer Data while the data is held in memory is more computationally efficient than querying issuer data sources each time that an information request is required by a user. As further indicated in FIG. 1C, once the raw issuer source data 108 is transformed and purified by the assimilator 152 and purifier operations 154, the new values 112 (clean issuer information) can be stored in a database 118A. From there, the database can be used to respond to one or more of a query 155 to generate a performance metric such as an indexed account segment crediting rate (158).

Purifiers 154 can include machine-readable instructions executed by the processor 102 to automatically screen transformed data which is an output of the system Assimilators 152 against a series of technical analytical checks to alert user(s) of the system 100 to the potential for missing/erroneous data in the original Source Issuer Data 108.

Data checks facilitated by the purifiers 154 are important because certain other systems will only transmit or receive data and will not evaluate if the transmitted/received data is incomplete or leads to investment outcomes that are outside the realm of possibility for a policy type, subaccount, indexed account, or time period of an asset class. Purifier algorithm checks include, but are not limited to:
1. Policy cash values that do not equal the sum of underlying subaccount and/or indexed account values
2. Trend analysis over multiple periods, to detect changes that are outside the realm of a statistically significant range, for
   1. Insurance death benefit amount
   2. Cash value balance
   3. Surrender charges
   4. Enhanced surrender value riders
   5. Cost of insurance charges
   6. Mortality & expense charges
   7. Administration charges
   8. Other charge types
   9. Loan balances
3. Transactions which should offset equally but have differing net balances such as transfers between subaccounts
4. Calculating hypothetical performance based on received transactions and holding values to detect if:
   a. Subaccount performance is outside a statistical range of allowed variance vs the realized performance of its classified asset class or strategy based on public benchmarks
   b. Investment performance for a policy, or group of policies, that is outside of a statistically significant range of potential outcomes for a period.
   c. Negative investment performance for select types of general crediting accounts/indexed accounts that are designed to have a guaranteed floor equal to or higher than 0% or asset classes that typically would not have negative market returns.

Any quality control flags identified by implementation of the purifiers 154 can be returned to the user.

In some examples, the purifiers 154 define data-cleansing algorithms that evaluate the transformed data (outputs of Assimilators) to assess if there is a statistical likelihood of an error in the Source Issuer Data received by the system in order to alert the user to the potential data deficiencies. Whereas other systems simply transmit Source Issuer Data, the purifiers 154 accommodate validations to the data after receipt before storage to a database. This is a technical improvement/solution because performing the data cleaning algorithms while information is held in memory is more computationally efficient than prior methods of querying a database of stored issuer data before performing data cleaning processes. Additionally-it is more computationally efficient to perform a single data cleaning upon receipt before storage, thus allowing all other queries of the stored information to bypass any data cleaning requirements, rather than performing data cleaning on queried information each time it is retrieved which results in duplicate computations performed on the information over time.

FIGS. 1D-1F illustrate an example of the operations performed in block 132 of FIG. 1B. As shown in FIG. 1D, the source issuer data 108 can take the form of one or more files 109 or other datasets/data input accessible by the processor 102. File 1 of FIG. 1D is an HTML file, and File 2 is a CSV file. As illustrated, each of the files contain information with different identifiers such as “A600,” “High Capped Account,” and the like. Yet, the processor 102 as configured by the present inventive concept can execute operations defined by the assimilators 152 to identify a type associated with each of File 1 and File 2, parse each file, extract desired information based upon the type of file, convert and/or transform information as needed, and otherwise generate new values from the source issuer data 108 to produce a visual display of the realized historical financial performance for the cash value of individual life insurance policies with uniform issuer comparability as described herein.

FIG. 1E illustrates greater detail about the transformation operations from the assimilators 152, and FIG. 1F provides expands upon concepts in FIG. 1E. FIG. 1E shows example assimilator outputs 160 by applying the operations of the assimilators 152 to information from the source issuer data 108 as extracted. In the example shown, the assimilator outputs 160 include a dataset of transactions corresponding to a transaction class defined by the data structure 114 and a dataset of holdings corresponding to a holdings class defined by the data structure 114. At least some of the data of the assimilator outputs 160 is derived from the source issuer data 108. For example, the second line of File 2 of FIG. 1D illustrating an issuer record of −$298.36 associated with a “A600” code and investment name classification of “HCIA” is transformed to new data structure 112 being an object with key-value pairs of “transaction_type: 13” and “asset_id: 88” which associates the −$298.36 transaction with being a cost of insurance deduction (system type 13) that is globally comparable, or combineable, in an analysis to any cost of insurance deduction from any other issuer (which are also coded to system type 13). Furthermore, the object's key-value pair for “asset_id: 88” associates the transaction with the specific investment fund High Capped Indexed Account of Issuer X (system id 88) allowing it to be used to calculate performance metrics in conjunction with holdings of that specific investment fund, regardless of whether other the source issuer data 108 labeled the fund as “HCIA” in the holding value data. In this example, shown in further detail in FIG. 1F, the processor 102 is configured to execute operations by the assimilators 152 to identify a type associated with the File 2 of FIG. 1D, parse the file for predetermined information corresponding to the file type (e.g., transactions from issuer X in a CSV file with rows and columns of data following a set pattern for how the issuer arranges data in its data), and in the example shown extract out specific information associated with one or more transactions. The information is then transformed to parameters and labels of the data structure 114. As further shown in FIG. 1E, the processor 102 further extracts holding information from one or more of the files 109 of FIG. 1D and transforms this information to a new dataset. To illustrate, a value of “High Capped Fund: $7,797.34” is extracted from File 1 of FIG. 1D a new object is generated as assimilator output (160) and associated with the key-value pair of “asset_id: 88” defined by the data structure 114. This is relevant because although File 1 and File 2 used different identifiers, High Capped Fund, and HCIA respectively, the new data 112 (labeled 162 in FIG. 1E) from the assimilators has associated the data as pertaining to the same investment fund, asset_id: 88, being the High Capped Indexed Account of Issuer X in human terms. Thereafter, this information is finally usable in a performance analysis which requires using both transactions and holdings of an investment to calculate a performance metric.

The final assimilator output 162 illustrated in FIG. 1E is a combination of the new datasets for holding and transactions information (assimilator outputs 160) derived from the source issuer data 108 that can stored according to the data structure 114 and queried as desired to produce any number of reports. A more detailed example of steps is provided below:
(1) Cache Source Issuer Data
   a. Collect files submitted by user and store in temporary application storage
(2) For each file in Source Issuer Data
   a. Identify Source Issuer Data
      i. file_type=Identify type of file
      ii. Do nothing and alert user if file_type is in disallowed list (e.g. exe, .sql, .xlsm)
      iii. Query database for Assimilator object where assimilator_data_type=file_type
      iv. For each assimilator in returned results apply stored assimilator_matching_function on data see if it matches all criteria in file
         1. If nothing skip to next file and include in notices to user that file failed
         2. Once a match is made advance to apply the assimilator_transformation of the
   b. Call referenced assimilator_transformation function and apply to Source Issuer Data. Each assimilator transformation will use its set of stored processes based on the data type and expected format to attempt a transformation of the Source Issuer Data to conform to the novel structure of the system data structure that is capable of holding information from multiple issuers.
      i. Parse
         1. Source Issuer Data other than .txt files with simple data structures
         a. For .CSV files utilize csv library
         b. For .DOCX files utilize python-docx library
         c. For .XLSX files utilize openpyxl library
         d. For .PDF files that are simple in structure utilize pypdf2 library
         e. For .JSON files utilize json library
         2. For files with complex data structures pass file to 3rd-party artificial intelligence document parser
         a. Connect to 3rd-party API using stored credentials in system
         b. Open file, read data and convert to bytes
         c. Submit data to 3rd-party artificial intelligence extraction service via asynchronous call and store response to an object
         3. Insert parsed data into a pandas dataframe
      ii. Isolate—each assimilator will seek some combination of the data points below in the data depending on what the assimilator is expecting in the file. The assimilator performs a series of pre-programmed steps to store the recognized data into a temporary data structure.
         1. Identifying information (necessary to associate records with appropriate account and period).
         a. As of Date
         b. Account Number
         c. Metadata
         i. Filename
         ii. User submitting file
         iii. Assimilator function used
         iv. Datetime
         v. Errors
         2. Policy-level Data
         a. Owner
         b. Insured
         c. Beneficiary
         d. Issue Date
         3. Supplemental
         a. Store Issuer Supplemental Label and value for any of these identified data points
         i. Death Benefit
         ii. Surrender Charge
         iii. Enhanced Surrender Value
         iv. Loan Balance
         4. Transactions
         a. For each transaction located collect the following:
         i. Transaction Date
         ii. Issuer Asset Label (defaults to suspense if none)
         iii. Issuer Transaction Type Label
         iv. Transaction Value
         5. Holdings
         a. For each holding located collect the following:
         i. Holding Date (if potentially different from as-of-date in the data overall)
         ii. Asset Label (defaults to suspense if none)
         iii. Holding Value
         iv. Holding Units
         v. Holding Unit Value
         6. Policy Segments
         a. For each segment located collect the following
         i. Indexed account
         ii. Policy segment date
         iii. Policy segment transfers in
         7. Illustration
         a. Isolate the ledger within the document with forecasted contributions, charges, and values and store as dataframe with rows as policy years and columns as fields from the Illustration object
      iii. Transform
         1. Appending account number to each data item collected, create separate objects that conform to the novel data structure of the system for:
         a. Account
         i. From Policy-Level Data assign to appropriate fields from Account object
         ii. Include other data captured mapped to object schema
         b. Holding
         i. Transform Asset Label to asset_id using Asset Mapping object
         ii. Include other data captured mapped to object schema
         c. Transaction
         i. Transform Issuer Transaction Type Label to transaction_type_id using Transaction Mapping object
         ii. Transform Asset Label to asset_id using Asset Mapping object
         iii. Include other data captured mapped to object schema
         d. Supplemental
         i. Transform Issuer Supplemental Type Label to supplemental_type_id using Supplemental Mapping object
         ii. Include other data captured mapped to object schema
         e. Policy Segments
         i. Utilizing Account Number lookup the Issuer Product object and then the appropriate Indexed Account Object for the data Indexed Account then the Indexed Segment object based on Indexed Account, Issuer Product and Policy segment date.
         ii. Insert the Indexed Segment object located in prior step
         iii. Include other data captured mapped to object schema
         f. Illustration
         i. Include data captured mapped to object schema
   c. Append Assimilator final output of file to a main data structure containing all the top-level objects
(3) Combine all Assimilator outputs in main data structure from the various files into a consolidated novel data structure that is conformed to the system and capable of storing Source Issuer Data from multiple issuers.

Returning back to FIG. 1D, as shown, data from the assimilator outputs 162 or “newData object” can be validated by applying operations of the purifiers 154 described herein. The purifiers 154 configure the processor 102 to clean issuer information that is capable of holding data from any insurance issuer of life insurance or annuities. This is novel because to-date no other system is available for commercial or research use that allows users to retrieve validated data on policies from multiple issuers in a single query. This is a technical improvement/solution because it is more computationally efficient to perform a single query for information on policies of multiple issuers than to perform multiple queries against various data sources and it is more computationally efficient to perform cleaning functions once upon ingestion than each time data is queried.

Referring back to block 133 of FIG. 1B, the processor 102 can further be configured to cause a display (122) to illustrate at least one performance metric (consolidated performance metrics 130 of FIG. 1A), such as the realized historical change of a policy's cash value from all of the plurality of files defining the issuer data collectively by applying a sole query to the new values associated with the data structure. In one example, the processor 102 as configured can provide a user with a consolidated Performance Analysis on a group of policies from various issuers that have different policy features, transaction types, data formats, and subaccount names for the same underlying fund-by using as input the new values 112 as generated above. This is novel because no other existing system can currently perform these performance calculations on a group of policies from various issuers due to the lack of the novel data structure 114 which is designed to be able to hold Clean Issuer Information from any insurance issuer. This is a technical improvement/solution because it is more computationally efficient to perform a single query against one data source and hold all data in memory to execute performance calculations than existing methods of querying multiple data sources and then performing various transformations for each data source before being able to execute performance calculations.

In addition, the processor 102 can be configured to estimate indexed account segment crediting from various issuer sources and allowing them to be shown side by side for multiple policies owned by the same owner which is a novel implementation. The implementation is a technical improvement/solution because performing ad-hoc estimated indexed account segment crediting from various issuer sources each time a user desires to see an analysis is computationally wasteful and results in duplicate queries and calculations when compared to the subject implementation of performing a single calculation within the database when new or updated Clean Issuer Information is loaded. By connecting the Indexed Account Segment Crediting Rate Calculation Engine (defined later) within a database storing the Clean Issuer Information to calculate and store indexed account segment crediting returns a user is able to perform an ad-hoc analysis of their policy performance, containing indexed account segments, in a more computationally efficient manner.

### Performance Analysis Engine (130A)

Referring still to block 133, and as shown as 130A in FIG. 1A, the processor 102 can be configured to execute operations (machine-readable instructions) to implement a performance analysis engine, or engine 130A.

Example algorithmic steps are provided below:

Define public variable minTransactionDate as minimum of transaction_date from transactionStaging
Build list of subPeriodDates where each item is a list with the first item as a date from the sorted ascending union of:
month-ending of reporStartDate through reportStartDate+1200 months and all unique dates from holdingStaging
   and the second item as the total days during the subperiod calculated as the difference between the first item in the child list and the first item of the proceeding item in the parent list
   Define fnWeightedValue as function with arguments (transaction_value, transaction_date):

```
      Set variables totalSubPeriodDays, priorSubPeriodDate = subPeriodDates [x][1],
subPeriodDates [x−1][0] where x is the item of the subperiodDates where transaction_date is
equal to or less than subPeriodDates [x][0] and greater than subPeriodDates[x−1][0]):
      Return transaction_value *
if(transaction_date=minTransactionDate, 1,Max(0,Min(1,Max(1, totalSubPeriodDays−
(transaction_date − priorSubPeriodDate))/totalSubPeriodDays)))
    For each account in list of accounts:
      Collect unique asset_id across holdingStaging and transactionStaging tables and save
to list accountAssets
      for each asset_id in accountAssets
        build assetCalc list of lists table with transaction, holding for that asset_id
          for each item in subPeriodDates with fields calculated as such:
              valueDate = item date
              priorPeriodDate = valueDate of prior item
              beginningValue = prior period holdingValue from n−1 row or 0 (if first
period)
              transfersIn = sum of transaction_value from transactionStaging where
transaction_type = transfers_in and transaction_date falls after priorPeriodDate and equal to
or before valueDate for item
              transfersOut = sum of transaction_value from transactionStaging where
transaction_type = transfers_out and transaction_date falls after priorPeriodDate and equal to
or before valueDate for item
              insuranceCharges = sum of transaction_value from transactionStaging
where transaction_type = insurance_deduction and transaction_date falls after
priorPeriodDate and equal to or before valueDate for item
              other = sum of transaction_value from transactionStaging where
transaction_type = other and transaction_date falls after priorPeriodDate and equal to or
before valueDate for item
            weightedTransfersIn = sum of fnWeightedValue(transaction_value,
transaction_date) of each transaction from transactionStaging where transaction_type =
transfers_in and transaction_date falls after priorPeriodDate and equal to or before valueDate
for item
            weightedTransfersOut = sum of fnWeightedValue(transaction_value,
transaction_date) of each transaction from transactionStaging where transaction_type =
transfers_out and transaction_date falls after priorPeriodDate and equal to or before
valueDate for item
            weightedInsuranceCharges = sum of fnWeightedValue(transaction_value,
transaction_date) of each transaction from transactionStaging where transaction_type =
insurance_deduction and transaction_date falls after priorPeriodDate and equal to or before
valueDate for item
            weightedOther = sum of fnWeightedValue(transaction_value,
transaction_date) of each transaction from transactionStaging where transaction_type = other
and transaction_date falls after priorPeriodDate and equal to or before valueDate for item
              holdingValue = lookup holding_value from holdingStaging where holding
_date is the valueDate for item. If no value then it is the prior holding Value from item n−1
              priceDate = if holding_value can be located for value_date then valueDate
otherwise valueDate for item n−1
              unitValue = lookup unit_value from holdingStaging where holding _date is
the month-end date for row. If no value then it is the prior unit_value from row n−1
              investmentExperience = holding_value − (beginning_value + transfers_in −
transfers_out − insurance_charges + other)
                if (unitValue != 0 and unitValue on row n−1 != 0) then
                  ror = (unitValue / unitValue on row n−1) − 1
                else
                ror = investmentExperience / (beginningValue + weightedTransfersIn
+ weightedTransfersOut + weightedInsuranceCharges + weightedOther) − 1
        append all rows and fields from constructed assetCalc to assetStaging table
Function CalculateAssetPerformance
    Create table assetTable and set to:
      For each asset_id in assetStaging table
        For each item in subPeriodDates:
          Sum beginning_value, transfers_in, transfers_out, insurance_charges, other,
investment_experience, holding_value and include minimum of unit_value, maximum of
price_date, and average of ror
          (This essentially combines assets accross acounts if held in more than one
account)
    Create table assets
    For each unique asset_id in assetTable append to assets:
      assetID = asset_id
      assetName = asset_name from asset table in database
      assetClass = asset_class from asset table in database
      asOfDate = price_date on reportDate
      investedDate = lookup the first value_date in assetTable for asset_id
      reportDateUnits = lookup unit_value on reportDate
      reportDateBalance = lookup holdingValue on reportDate
      for period1 through period3 (as period x) repeat these fields
        periodXPartial = investedDate < period_x_begin_date
        periodXbeginBalance = lookup beginning_value on period_x_begin_date
        periodXtransfersIn = sum of transfers_in from period_x_begin_date to
period_x_end date
        periodXtransfersOut = sum of transfers_out from period_x_begin_date to
period_x_end date
        periodXInvestmentExperience = sum of investment_experience from
period_x_begin_date to period_x_end_date
        periodXInsuranceCharges = sum of insurance_charges from period_x_begin_date
to period_x_end date
        periodXOther = sum of other from period_x_begin_date to period_x_end_date
        periodXEndingBalance = lookup holding_value on period_x_end_date
        periodXROR =
          [
            (product of all results for n from period_x_begin_date through period_x_end
date where result on each n = 1 + ror on n date)
            \hat{ } minimum (1, 365 / days during periodX) − 1
          ]
  Function CalculateTotalPerformance
    Create table totalTable and with n rows for each item in subPeriodDates. For each row
calculate
      valueDate = subPeriodDates[n][0]
      priorPeriodDate = valueDate from subPeriodDates[n−1][0]
      beginningValue = endingValue from n−1 or 0 if first period
      contributions = sum of suspenseTransactions where transaction_type = contribution
with transaction_date <= valueDate and > priorPeriodDate
      premiumLoad = sum of suspenseTransactions where transaction_type =
premium_load with transaction_date <= valueDate and > priorPeriodDate
      costOfInsurance = sum of suspenseTransactions where transaction_type =
cost_of_insurance with transaction_date <= valueDate and > priorPeriodDate
      administrationCharge = sum of suspenseTransactions where transaction_type =
administration with transaction_date <= valueDate and > priorPeriodDate
      mortalityExpense = sum of suspenseTransactions where transaction_type =
mortality_expense with transaction_date <= valueDate and > priorPeriodDate
      investmentOptionCharges = sum of suspenseTransactions where transaction_type =
investment_option_charge with transaction_date <= valueDate and > priorPeriodDate
      riderCharges = sum of suspenseTransactions where transaction_type = rider_charge
with transaction_date <= valueDate and > priorPeriodDate
      fundInsuranceCharges = sum of insuranceCharges on assetStaging with
transaction_date <= valueDate and > priorPeriodDate
      withdrawals = sum of suspenseTransactions where transaction_type = withdrawal
with transaction_date <= valueDate and > priorPeriodDate
      claimCashValueDeductions = sum of suspenseTransactions where transaction_type =
claim with transaction_date <= valueDate and > priorPeriodDate
      other = sum of other in transactionStaging where transaction_type = other with
transaction_date <= valueDate and > priorPeriodDate
      endingValue = sum of holdingValue on assetStaging on n valueDate
      investmentExperience = endingValue − (beginning Value + contributions −
premiumLoad − costOfInsurance − administrationCharge − mortality Expense −
investmentOptionCharges − riderCharges − withdrawals − claimCashValueDeductions + other)
      weightedContributions = sum of fnWeightedValue(transaction_value,
transaction_date) for all suspenseTransactions where transaction_type = contribution with
transaction_date <= valueDate and > priorPeriodDate
      weightedPremiumLoad = sum of fnWeightedValue(transaction_value,
transaction_date) for all suspenseTransactions where transaction_type = premium_load with
transaction_date <= valueDate and > priorPeriodDate
      weightedCostOfInsurance = sum of fnWeightedValue(transaction_value,
transaction_date) for all suspenseTransactions where transaction_type = cost_of_insurance
with transaction_date <= valueDate and > priorPeriodDate
      weightedAdministrationCharge = sum of fnWeightedValue(transaction_value,
transaction_date) for all suspenseTransactions where transaction_type =
administration_charge with transaction_date <= valueDate and > priorPeriodDate
      weightedMortalityExpense = sum of fnWeightedValue(transaction_value,
transaction_date) for all suspenseTransactions where transaction_type = mortality_expense
with transaction_date <= valueDate and > priorPeriodDate
      weightedInvestmentOptionCharges = sum of fnWeightedValue(transaction_value,
transaction_date) for all suspenseTransactions where transaction_type =
investment_option_charge with transaction_date <= valueDate and > priorPeriodDate
      weightedRiderCharges = sum of fnWeightedValue(transaction_value,
transaction_date) for all suspenseTransactions where transaction_type = rider_charge with
transaction_date <= valueDate and > priorPeriodDate
      weightedWithdrawals = sum of fnWeightedValue(transaction_value,
transaction_date) for all suspenseTransactions where transaction_type = withdrawal with
transaction_date <= valueDate and > priorPeriodDate
      weightedClaimCashWithdrawal = sum of fnWeightedValue(transaction_value,
transaction_date) for all suspenseTransactions where transaction_type = claim with
transaction_date <= valueDate and > priorPeriodDate
      weightedOther = sum of fnWeightedValue(transaction_value, transaction_date) for all
transactionStaging where transaction_type = other with transaction_date <= valueDate and >
priorPeriodDate
      grossOfInsuranceChargesReturn = [
                  investmentExperience / (
                      beginningValue +
                      weightedContributions −
                      weightedPremiumLoad −
                      weightedCostOfInsurance −
                      weightedAdministrationCharge −
                      weightedMortalityExpense −
                      weightedInvestmentOptionCharges −
                      weightedRiderCharges −
                      weightedWithdrawals −
                      weightedClaimCashWithdrawal +
                      weightedOther
                      )
                  ]
      netOfInsuranceChargesReturn = [
                  (investmentExperience −
                  premiumLoad −
                  costOfInsurance −
                  administrationCharge −
                  mortalityExpense −
                  investmentOptionCharges −
                  riderCharges
                  )
                  /
                  (beginningValue +
                  weightedContributions −
                  weightedWithdrawals −
                  weightedClaimCashWithdrawal +
                  weightedOther
                  )
                  ]
      active = is endingValue > 0
    calculate the summaryTotalTable for each period in period1 through period3 based on
begin/end dates in template settings using data from totalTable
      totalbeginningValue = sum of beginningValue for period_x_begin_date
      totalcontributions = sum of contributions from period_x_begin_date through
period_x_end_date
      totalpremiumLoad = sum of premiumLoad from period_x_begin_date through
period_x_end_date
      totalcostOfInsurance = sum of costOfInsurance from period_x_begin_date through
period_x_end_date
      totaladministrationCharge = sum of administrationCharge from period_x_begin_date
through period_x_end_date
      totalmortalityExpense = sum of mortality Expense from period_x_begin_date through
period_x_end_date
      totalinvestmentOptionCharges = sum of investmentOptionCharges from
period_x_begin_date through period_x_end_date
      riderCharges = sum of riderCharges from period_x_begin_date through
period_x_end_date
      totalfundInsuranceCharges = sum of fundInsuranceCharges from
period_x_begin_date through period_x_end_date
      totalwithdrawals = sum of withdrawals from period_x_begin_date through
period_x_end_date
      totalclaimCashValueDeductions = sum of claimCashValueDeductions from
period_x_begin_date through period_x_end_date
      totalother = sum of other from period_x_begin_date through period_x_end_date
      investmentExperience = sum of investmentExperience from period_x_begin_date
through period_x_end_date
      totalendingValue = endingValue for period_x_end_date
      totalgrossOfInsuranceChargesReturn = [
                    (product of all results for n from period_x_begin_date
through period_x_end date where result on each n = 1 + grossOfInsuranceChargesReturn on
n date)
                    \hat{ } minimum (1, 365 / days during periodX) − 1
                  ]
      totalnetOfInsuranceChargesReturn = [
                    (product of all results for n from period_x_begin_date
through period_x_end date where result on each n = 1 + netOfInsuranceChargesReturn on n
date)
                    \hat{ } minimum (1, 365 / days during periodX) − 1
                  ]
```

### Indexed Account Segment Crediting Rating Calculation Engine (130B)

Referring still to block 133, and as shown as 130B in FIG. 1A, the processor 102 can be configured to execute operations (machine-readable instructions) to implement an Indexed Account Segment Crediting Rating Calculation Engine, or engine 130B.

Example algorithmic steps are provided below:
Engine is triggered to update any indexed_segment_return_id upon a change in any of the underlying for that indexed_segment_return_id:
   market_index_value_id
   indexed_segment_terms_id.
Additionally, the engine is triggered to create new indexed_segment_return_id whenever:
   a new indexed_segment_id is added to the system
   a new reporting period (for example daily/monthly/quarterly) has passed, date referred to here as calculationDate
   the current date passes the maturity date of an indexed_segment_id in the system.
For each affected indexed_segment_id do the following:
   Collect all terms from the associated Indexed Terms object
   For each indexed_underyling of an Indexed Terms object
      Collect the market_index_value for the market_index_id on:
         the indexed_segment_start_date,
         if possible, the indexed_segment_maturity_date
         if possible, the calculationDate
      Update (if existing indexed_segment_id) or create (if new indexed_segment_id) the indexed_segment_return_crediting_rate with the collected terms and market values with the following function:

```
MAX(
  Floor Rate,
  MIN(
    Cap Rate,
    For all underlying indexes (Weight
    ((IndexValueEnd / Index ValueBegin − 1) − HurdleRate) *
    ParticipationRate )
    )
  )
) * Multiplier Rate
+ Booster Rate
```

If the action causing the calculation is the passing of a indexed_segment_maturity_date then set indexed_segment_return_matured to true, otherwise false

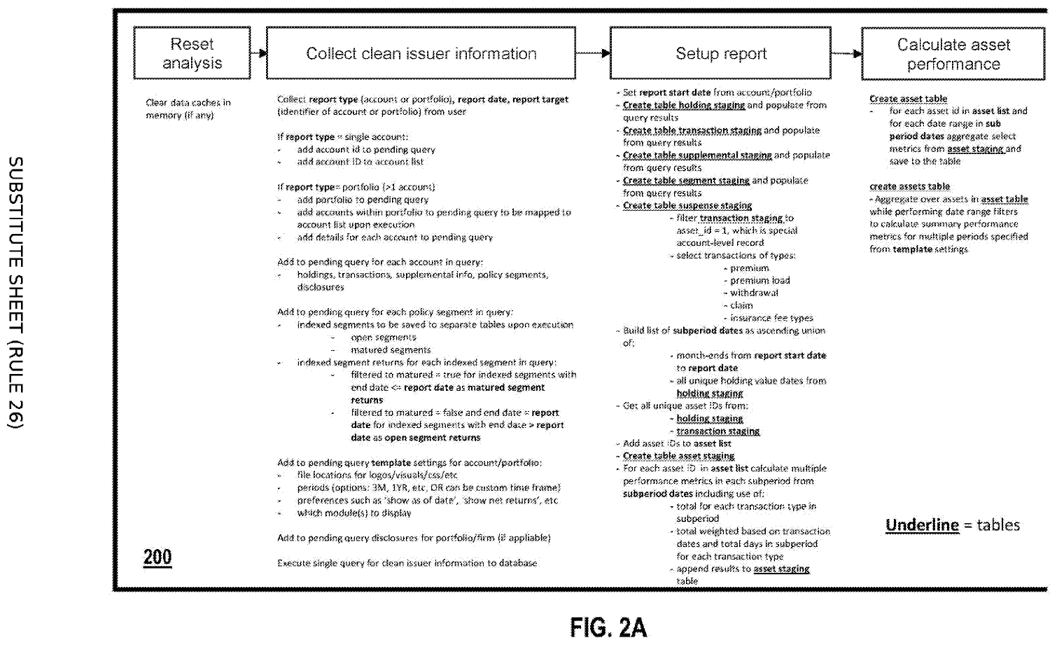

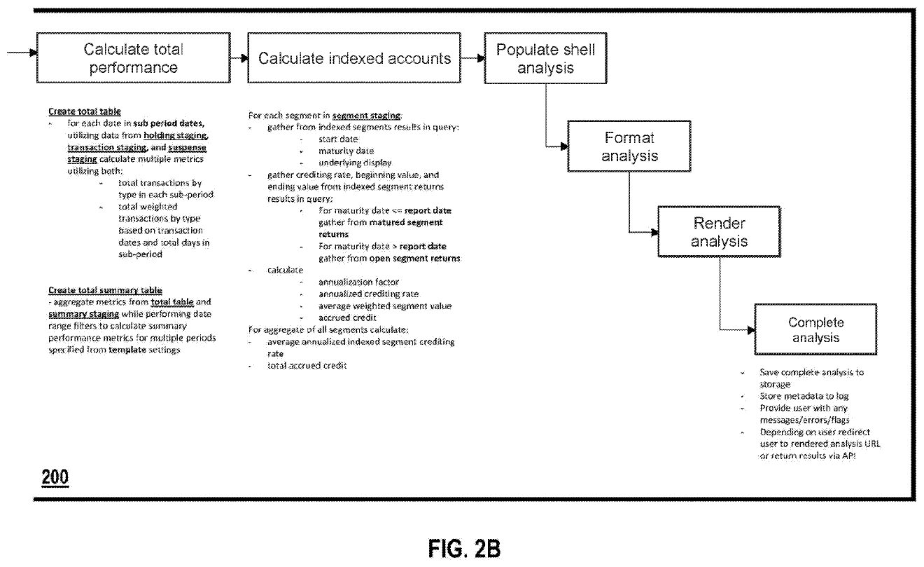

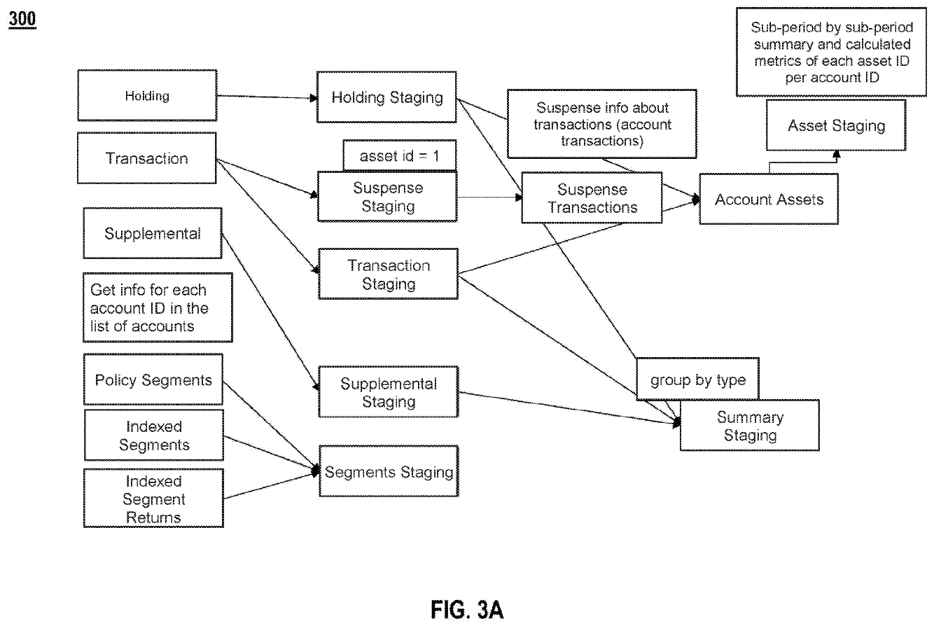

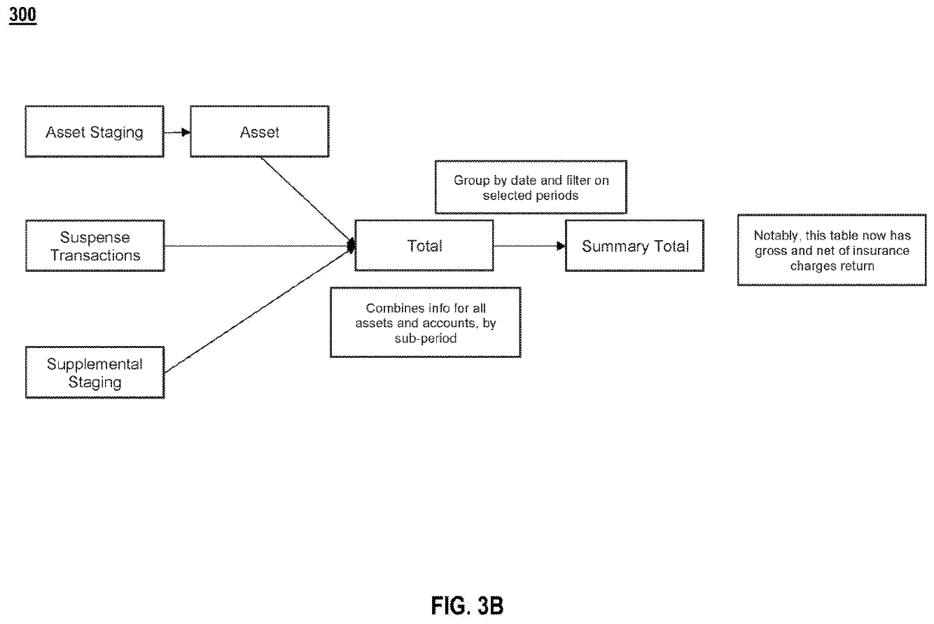

FIGS. 2A-2B provide another example of general data flow for running a report for an end user. FIGS. 3A-3B depict a relationship diagram illustrating database table flow associated with example tables created, populated, modified, or otherwise implemented via the system of FIG. 1A.

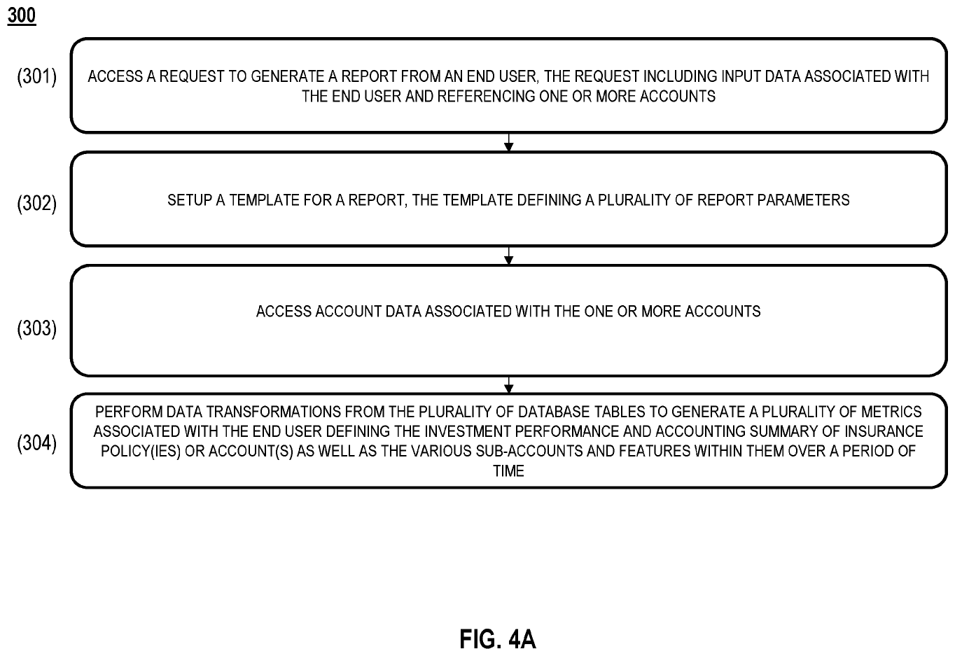

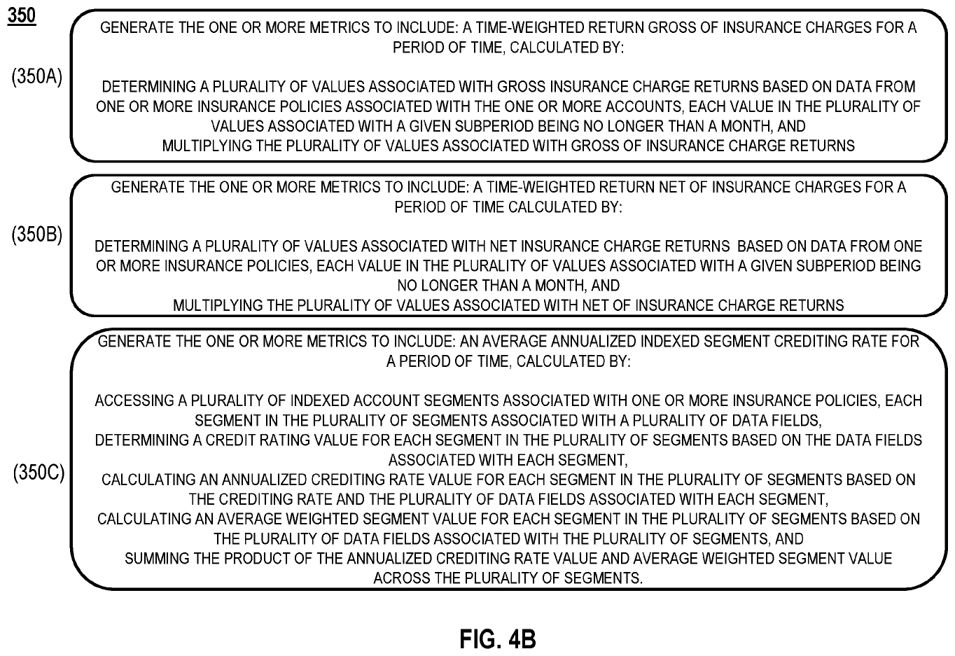

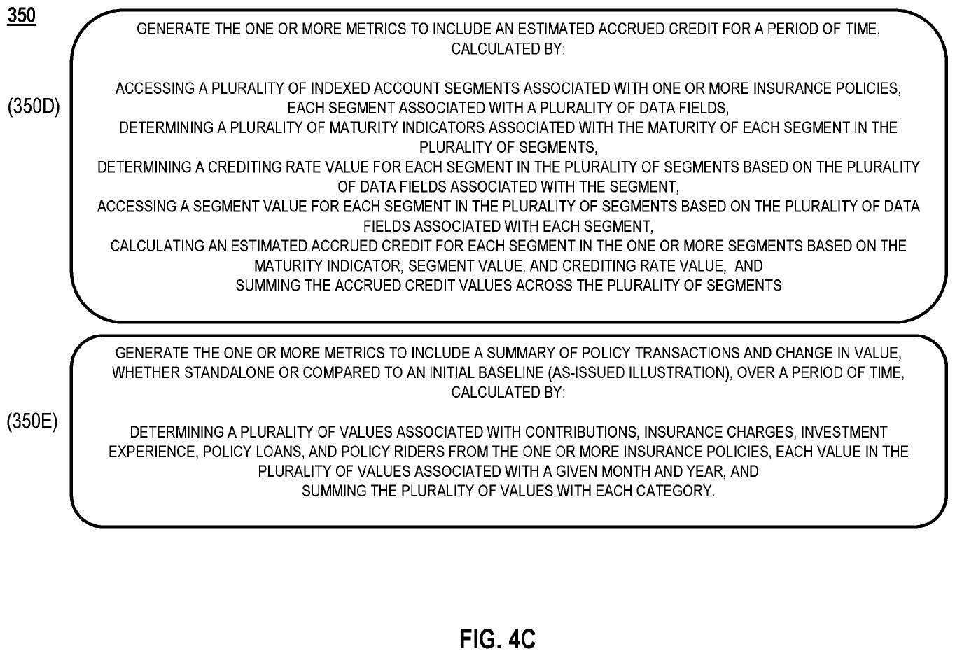

Referring to FIG. 4A, one example process flow 300 associated with an implementation of the system 100 is provided. In general, output of the process flow 300 includes one or more metrics (116) computed by the processor 102 that can be provided to the display 108. FIGS. 4B-4C provide examples of the output metrics 116.

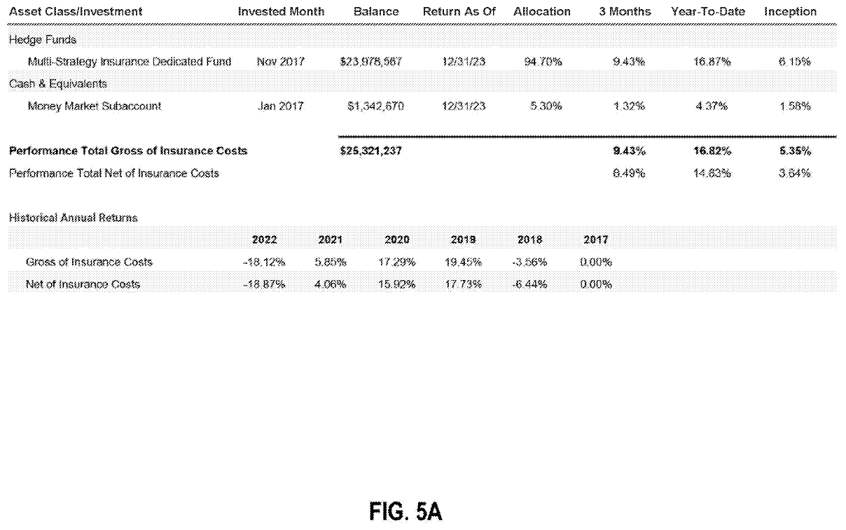

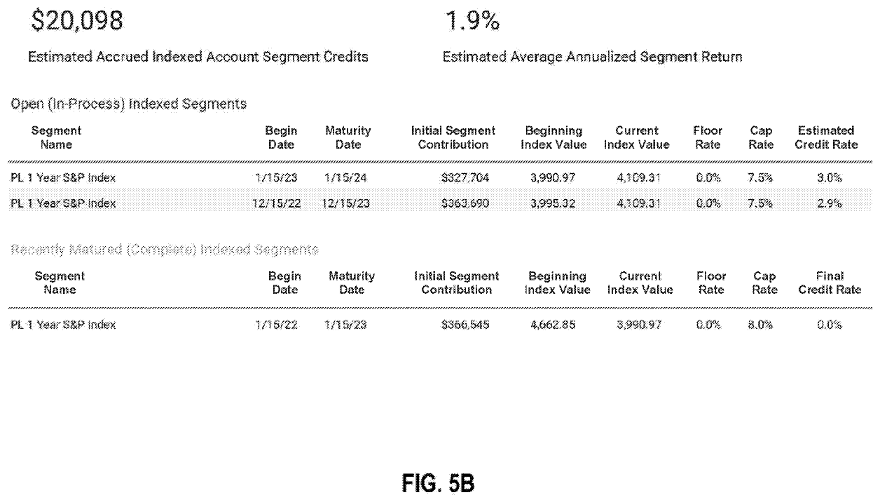

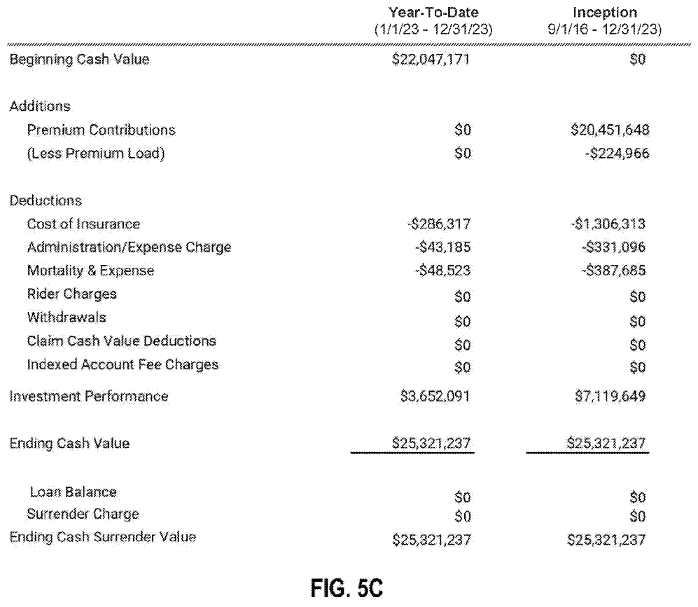

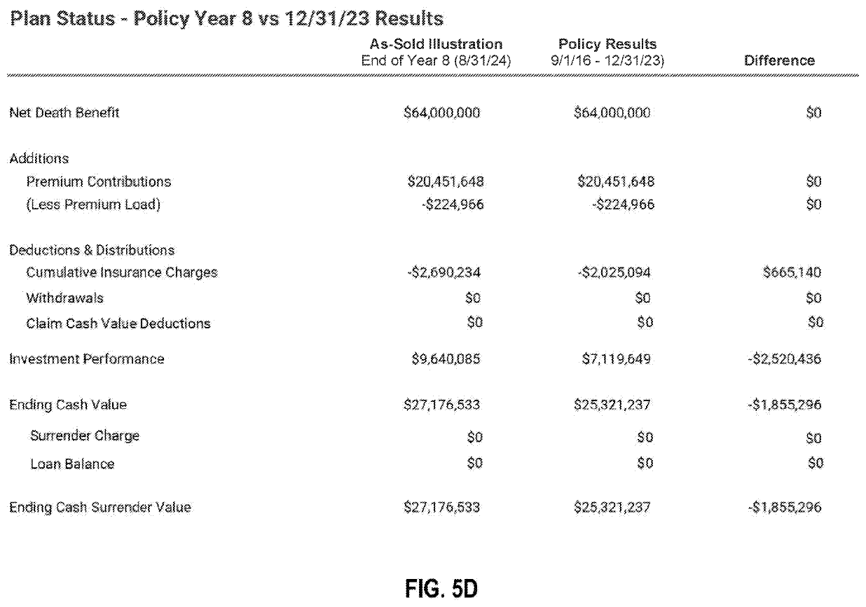

FIGS. 5A-5D illustrate examples supporting the output metrics 116 of FIGS. 4B-4C. Specifically, FIG. 5A supports blocks 350A and 350B of FIG. 4B; FIG. 5B supports blocks 350C of FIGS. 4B and 350D of FIG. 4C, and FIGS. 5C-5D support block 350E of FIG. 4C.

### Exemplary Computing Device

Referring to FIG. 6, a computing device 1200 is illustrated which may be configured, via the instructions 104 and/or other computer-executable instructions, to execute functionality described herein. More particularly, in some embodiments, aspects of the display system herein may be translated to software or machine-level code, which may be installed to and/or executed by the computing device 1200 such that the computing device 1200 is configured to execute display functionality described herein. It is contemplated that the computing device 1200 may include any number of devices, such as personal computers, server computers, hand-held or laptop devices, tablet devices, multiprocessor systems, microprocessor-based systems, set top boxes, programmable consumer electronic devices, network PCs, minicomputers, mainframe computers, digital signal processors, state machines, logic circuitries, distributed computing environments, and the like.

The computing device 1200 may include various hardware components, such as a processor 1202, a main memory 1204 (e.g., a system memory), and a system bus 1201 that couples various components of the computing device 1200 to the processor 1202. The system bus 1201 may be any of several types of bus structures including a memory bus or memory controller, a peripheral bus, and a local bus using any of a variety of bus architectures. For example, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computing device 1200 may further include a variety of memory devices and computer-readable media 1207 that includes removable/non-removable media and volatile/nonvolatile media and/or tangible media, but excludes transitory propagated signals. Computer-readable media 1207 may also include computer storage media and communication media. Computer storage media includes removable/non-removable media and volatile/nonvolatile media implemented in any method or technology for storage of information, such as computer-readable instructions, data structures, program modules or other data, such as RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information/data and which may be accessed by the computing device 1200. Communication media includes computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. For example, communication media may include wired media such as a wired network or direct-wired connection and wireless media such as acoustic, RF, infrared, and/or other wireless media, or some combination thereof. Computer-readable media may be embodied as a computer program product, such as software stored on computer storage media.

The main memory 1204 includes computer storage media in the form of volatile/nonvolatile memory such as read only memory (ROM) and random access memory (RAM). A basic input/output system (BIOS), containing the basic routines that help to transfer information between elements within the computing device 1200 (e.g., during start-up) is typically stored in ROM. RAM typically contains data and/or program modules that are immediately accessible to and/or presently being operated on by processor 1202. Further, data storage 1206 in the form of Read-Only Memory (ROM) or otherwise may store an operating system, application programs, and other program modules and program data.

The data storage 1206 may also include other removable/non-removable, volatile/nonvolatile computer storage media. For example, the data storage 1206 may be: a hard disk drive that reads from or writes to non-removable, nonvolatile magnetic media; a magnetic disk drive that reads from or writes to a removable, nonvolatile magnetic disk; a solid state drive; and/or an optical disk drive that reads from or writes to a removable, nonvolatile optical disk such as a CD-ROM or other optical media. Other removable/non-removable, volatile/nonvolatile computer storage media may include magnetic tape cassettes, flash memory cards, digital versatile disks, digital video tape, solid state RAM, solid state ROM, and the like. The drives and their associated computer storage media provide storage of computer-readable instructions, data structures, program modules, and other data for the computing device 1200.

A user may enter commands and information through a user interface 1240 (displayed via a monitor 1260) by engaging input devices 1245 such as a tablet, electronic digitizer, a microphone, keyboard, and/or pointing device, commonly referred to as mouse, trackball or touch pad. Other input devices 1245 may include a joystick, game pad, satellite dish, scanner, or the like. Additionally, voice inputs, gesture inputs (e.g., via hands or fingers), or other natural user input methods may also be used with the appropriate input devices, such as a microphone, camera, tablet, touch pad, glove, or other sensor. These and other input devices 1245 are in operative connection to the processor 1202 and may be coupled to the system bus 1201, but may be connected by other interface and bus structures, such as a parallel port, game port or a universal serial bus (USB). The monitor 1260 or other type of display device may also be connected to the system bus 1201. The monitor 1260 may also be integrated with a touch-screen panel or the like.

The computing device 1200 may be implemented in a networked or cloud-computing environment using logical connections of a network interface 1203 to one or more remote devices, such as a remote computer. The remote computer may be a personal computer, a server, a router, a network PC, a peer device or other common network node, and typically includes many or all of the elements described above relative to the computing device 1200. The logical connection may include one or more local area networks (LAN) and one or more wide area networks (WAN), but may also include other networks. Such networking environments are commonplace in offices, enterprise-wide computer networks, intranets and the Internet.

When used in a networked or cloud-computing environment, the computing device 1200 may be connected to a public and/or private network through the network interface 1203. In such embodiments, a modem or other means for establishing communications over the network is connected to the system bus 1201 via the network interface 1203 or other appropriate mechanism. A wireless networking component including an interface and antenna may be coupled through a suitable device such as an access point or peer computer to a network. In a networked environment, program modules depicted relative to the computing device 1200, or portions thereof, may be stored in the remote memory storage device.

Certain embodiments are described herein as including one or more modules. Such modules are hardware-implemented, and thus include at least one tangible unit capable of performing certain operations and may be configured or arranged in a certain manner. For example, a hardware-implemented module may comprise dedicated circuitry that is permanently configured (e.g., as a special-purpose processor, such as a field-programmable gate array (FPGA) or an application-specific integrated circuit (ASIC)) to perform certain operations. A hardware-implemented module may also comprise programmable circuitry (e.g., as encompassed within a general-purpose processor or other programmable processor) that is temporarily configured by software or firmware to perform certain operations. In some example embodiments, one or more computer systems (e.g., a standalone system, a client and/or server computer system, or a peer-to-peer computer system) or one or more processors may be configured by software (e.g., an application or application portion) as a hardware-implemented module that operates to perform certain operations as described herein.

Accordingly, the term “hardware-implemented module” encompasses a tangible entity, be that an entity that is physically constructed, permanently configured (e.g., hardwired), or temporarily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure the processor 1202, for example, to constitute a particular hardware-implemented module at one instance of time and to constitute a different hardware-implemented module at a different instance of time.

Hardware-implemented modules may provide information to, and/or receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and may store the output of that operation in a memory device to which it is communicatively coupled. A further hardware-implemented module may then, at a later time, access the memory device to retrieve and process the stored output. Hardware-implemented modules may also initiate communications with input or output devices.

Computing systems or devices referenced herein may include desktop computers, laptops, tablets e-readers, personal digital assistants, smartphones, gaming devices, servers, and the like. The computing devices may access computer-readable media that include computer-readable storage media and data transmission media. In some embodiments, the computer-readable storage media are tangible storage devices that do not include a transitory propagating signal. Examples include memory such as primary memory, cache memory, and secondary memory (e.g., DVD) and other storage devices. The computer-readable storage media may have instructions recorded on them or may be encoded with computer-executable instructions or logic that implements aspects of the functionality described herein. The data transmission media may be used for transmitting data via transitory, propagating signals or carrier waves (e.g., electromagnetism) via a wired or wireless connection.

It is believed that the present disclosure and many of its attendant advantages should be understood by the foregoing description, and it should be apparent that various changes may be made in the form, construction, and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it should be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

1. A method of generating a visual display of the realized historical financial performance for the cash value of individual life insurance policies with uniform issuer comparability, comprising:
accessing source issuer data defined from a plurality of files containing individual life insurance policy information;
generating by a processor an instance of a data structure from input of the plurality of files, the data structure defining a predetermined storage format including a set of parameters configured for accommodating queries for the investment performance and dissection of the components of change for the cash value of life insurance policies to all of the plurality of files collectively, by:
identifying a type associated with each of the plurality of files,
extracting information from each of the plurality of files, the historical details of a policy's cash value, extracted based on the type,
applying one or more transformations to the information as extracted to generate new values corresponding to the set of parameters of the data structure, the one or more transformations uniquely tailored for the type of file, and
mapping the new values from each file to corresponding parameters of the set of parameters of the data structure to represent all of the plurality of files collectively by the data structure; and
generating a display that illustrates a performance metric being the realized historical change of a policy's cash value from all of the plurality of files defining the issuer data collectively by applying a sole query to the new values associated with the data structure.

2. The method of claim 1, wherein the performance metric includes a time-weighted return of the policy cash value, and any subaccounts the cash value is allocated to, gross, meaning excluding the effect of the deduction, of insurance charges for a period of time for a plurality of issuer policies.

3. The method of claim 1, wherein the performance metric derived using the data structure includes a consolidated cash value performance analysis on a group of policies from various issuers that have different policy features, transaction type naming conventions, data formats, and differing subaccount names for certain insurance dedicated funds.

4. The method of claim 1, further comprising:
performing at least one data cleansing function to the information as extracted and transformed to assess a statistical likelihood of error and identify potential data deficiencies.

5. The method of claim 1, wherein at least one parameter defined by the predetermined storage format of the data structure corresponds to a new variable insurance cost parameter and the one or more transformations generates a new value for the new variable insurance cost parameter for each of the plurality of files.

6. The method of claim 1, wherein the new values represent new data generated by the one or more transformations for each file that is not defined within the plurality of files prior to the one or more transformations, the new data accommodating computation of a time-weighted return for a policy cash value net of insurance charges for a period of time for all of the plurality of files associated with the different issuer data sources all at once.

7. The method of claim 1, further comprising generating the performance metric by computing, according to the sole query and leveraging the data structure, an estimated indexed account segment crediting for a plurality of indexed account segments of a policy which have not matured by the effective date of an analysis, from the different issuer data sources, the display rendering the estimated deferred crediting for each indexed account segment, subject to the terms of the segment such as indexed caps, floors, participation rates, multipliers, boosters, hurdles, and rider charges and while considering the value of public market indexes at the inception of each segment until the effective date of the analysis.

8. The method of claim 7, displayed as the consolidated value of the estimated indexed account segment crediting for all indexed account segments of a policy which have not matured by the effective date of an analysis.

9. The method of claim 1, further comprising generating the performance metric by computing, according to the sole query and leveraging the data structure, the average annualized crediting rate for all indexed account segments of a policy for both known final crediting rates of matured segments and the estimated deferred credits of claim 7 as of the effective date of the analysis.

10. (canceled)

11. The method of claim 1, wherein the display renders a side-by-side comparison of the aspects of an as-sold illustration of a policy such as forecasted cumulative premium paid, cumulative insurance charges, and estimated illustration point-in-time values such as cash value, surrender value, death benefit, and loan balance through the current policy year as of the effective date of an analysis compared to the realized cumulative financial outcomes of policies for the same aspects from inception of a policy through the effective date of an analysis.

12. The method of claim 11, with the display rendering aspects of the as-sold illustration compared to realized financial outcomes of policies from different issuer data sources in the same analysis and comparable to one another for multiple policies associated with a common user.
